(19) United States
(12) Patent Application Publication
(10) Pub. No.: US 2026/0205303 A1
(43) Pub. Date: Jul. 16, 2026

(54) Signed Data Structure Pre-Authentication for Integrated Circuit Device

(71) Applicant: Altera Corporation, San Jose, CA (US)

(72) Inventors: Michael Neve de Mevergnies, Guidel (FR); Andrew Draper, Chesham (GB); Anthony Cartolano, Cedar Park, TX (US); Aditya Katragada, Austin, TX (US); Geoffrey Strongin, Austin, TX (US)

(21) Appl. No.: 19/465,878

(22) Filed: Jan. 30, 2026

(51) Int. Cl. H04L 9/32; G06F 21/57

(52) U.S. Cl. CPC H04L 9/3242; G06F 21/575; G06F 2221/034

(57) ABSTRACT

Systems, methods, and circuitry for pre-authentication of a signed data structure are provided. An integrated circuit device may include a device controller to verify a signature of a signed data structure based on, during an initial boot sequence, computing a full signature verification and computing and storing a message authentication code and, during a subsequent boot sequence, recomputing the message authentication code and comparing the recomputed message authentication code to the stored message authentication code. The integrated circuit device may include data utilization circuitry to use the signed data structure based on the signature of the signed data structure being verified.

### BACKGROUND

This disclosure relates to authentication of data structures for integrated circuit devices and, more particularly, to pre-authentication of signed data structures for reducing boot or configuration times.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionality. Many integrated circuits include programmable logic circuitry that may be configured with a hardware system design to implement hardware designs that may perform a wide variety of different functions. Some integrated circuit devices, such as field programmable gate arrays (FPGAs), are often configured using bitstreams that define the logic and routing for the programmable logic circuitry. To protect against unauthorized modifications and ensure authenticity, bitstreams may be signed using digital signatures that are verified by the device prior to configuration. As security requirements have evolved, including support for post-quantum cryptographic algorithms, the computational complexity of signature verification has increased. Approaches to reduce boot time have included increasing boot frequency, simplifying boot flows, and integrating hardware accelerators, though these approaches face practical limitations related to frequency scaling constraints, silicon area consumption, and feature requirements that add complexity to boot flows.

In the context of partial reconfiguration, where portions of the programmable logic are reconfigured while other portions remain operational, the duration of the reconfiguration process affects device efficiency. The time spent performing cryptographic verification of partial reconfiguration images contributes to the downtime between reconfigurations. Given that bitstreams are typically used numerous times in production systems, approaches that can reduce the time associated with repeated authentication of the same data structures may provide benefits across various applications.

### BRIEF DESCRIPTION OF THE DRAWINGS

Various aspects of this disclosure may be better understood upon reading the following detailed description and upon reference to the drawings in which:

FIG. 1 is a block diagram of a system used to program a system design onto an integrated circuit device;

FIG. 2 is a block diagram of an example integrated circuit device that may be programmed with a system design;

FIG. 3 illustrates a flowchart for a method for pre-authentication of signed data structures;

FIG. 4 illustrates a block diagram of an initial boot process for the integrated circuit device of FIG. 2;

FIG. 5 illustrates a block diagram of a fast boot process for the integrated circuit device of FIG. 2;

FIG. 6 illustrates a flowchart for a process for pre-validation and reconfiguration of partial reconfiguration images; and

FIG. 7 is a block diagram of a data processing system that incorporates the systems and methods of this disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” “e.g.,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Integrated circuit devices, such as field-programmable gate arrays (FPGAs), may undergo authentication processes when they read in a new signed data structure, such as when they read a signed configuration bitstream during boot and configuration operations. These authentication processes may involve verifying digital signatures associated with signed data structures, such as bitstreams, firmware images, or certificates, before operating on the signed data structures (e.g., configuring the integrated circuit device using a signed configuration bitstream). Verifying the digital signature may consume a substantial amount of time and energy, particularly when post-quantum cryptographic algorithms are employed. Some post-quantum signature verification algorithms may even involve thousands of hash operations to complete verification of a single signed data structure.

To reduce boot and configuration times, a pre-authentication approach may be used. During an initial boot cycle, the integrated circuit device may perform a full signature verification. To avoid performing the full signature verification in the future, the integrated circuit may also generate a pre-authentication record. The pre-authentication record may include a message authentication code (MAC) that is computed based on a digest of the signed data structure, a device-unique secret such as a secret key, and a monotonic counter value associated with the device state. The pre-authentication record may be stored locally or in external storage, such as system flash memory, alongside the corresponding signed data structure.

Thereafter, when the same signed data structure is provided to the integrated circuit device again in the future, the integrated circuit device may authenticate the signed data structure using the pre-authentication record. The integrated circuit device may recompute the pre-authentication record using the same device-unique secret and monotonic counter values, and may compare the recomputed pre-authentication record against the received pre-authentication record. When the pre-authentication records match, the integrity and authenticity of the signed data structure may be confirmed without performing the full digital signature verification. This approach may reduce boot and configuration times by replacing computationally intensive signature verification operations with much faster MAC-based verification operations.

Even so, the pre-authentication approach may maintain security equivalent to full signature verification. Because the pre-authentication record is computed using a device-unique secret that is not accessible outside the integrated circuit device, an attacker cannot forge a valid pre-authentication record without access to the device-specific secret. Additionally, the inclusion of monotonic counter values in the pre-authentication record computation may prevent replay attacks, as incrementing the monotonic counter will invalidate previously generated pre-authentication records.

The pre-authentication approach may be applied to various types of signed data structures beyond boot-time bitstreams. For example, the approach may be applied to partial reconfiguration images, validation bitstreams, tokens, and other authenticated data structures. In the context of partial reconfiguration, pre-validation of a next partial reconfiguration image may be performed while a current partial reconfiguration region is still operating, thereby reducing downtime during reconfiguration operations.

The pre-authentication record generation and verification operations may be performed using quantum-resistant cryptographic primitives, such as secure hash algorithms (SHA) and advanced encryption standard (AES) operations. These primitives may provide resistance against quantum-based attacks while still using fewer computational operations than post-quantum digital signature verification algorithms.

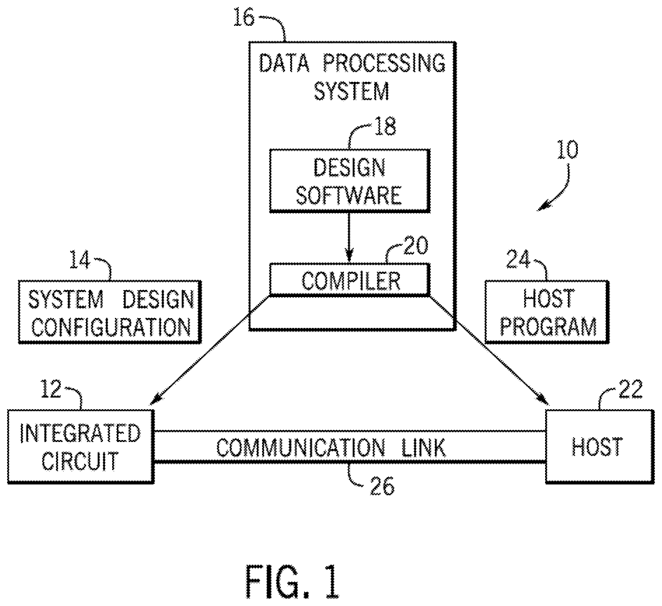

FIG. 1 illustrates a block diagram of a system 10 that may be used to program an integrated circuit device 12, such as an FPGA (e.g., Agilex™, Stratix®, Arria®, MAX®, or Cyclone® devices by Altera® Corporation), with such a system design in a system design configuration 14. Note that, while this disclosure largely refers to the integrated circuit device 12 as being a programmable logic device, such as an FPGA, in some embodiments, the integrated circuit device 12 may also be a one-time programmable device or structured application specific integrated circuit (ASIC), such as an Altera® eASIC™ device by Altera® Corporation. In other examples, the integrated circuit device 12 may be any suitable integrated circuit that is manufactured to have a particular system design with circuitry to perform desired data processing operations. The integrated circuit device 12 may be a single monolithic integrated circuit or a multi-die system of integrated circuits. The integrated circuit device 12 may include a single integrated circuit, multiple integrated circuits in a package, or multiple integrated circuits in multiple packages communicating remotely (e.g., via wires or traces) and may be referred to as an integrated circuit device or an integrated circuit system whether formed from a single integrated circuit or multiple integrated circuits in a package.

A designer may desire to implement the system design 14 (sometimes referred to as a circuit design or configuration) to perform a wide variety of possible operations on the integrated circuit device 12. In some cases, the designer may specify a high-level program to be implemented, such as an OPENCL® program that may enable the designer to more efficiently and easily provide programming instructions to configure a set of programmable logic cells for the integrated circuit device 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

In a configuration mode of the integrated circuit device 12, a designer may use a data processing system 16 (e.g., a computer including a data processing system having a processor and memory or storage) to implement high-level designs (e.g., a system user design) using design software 18 (e.g., executable instructions stored in a tangible, non-transitory, computer-readable medium such as the memory or storage of the data processing system 16), such as a version of Altera® Quartus® by Altera Corporation. The data processing system 16 may use the design software 18 and a compiler 20 to convert the high-level program into a lower-level description (e.g., a configuration program, a bitstream) as the system design configuration 14. The designer may use the design software 18 to generate and/or to specify a low-level program, using low-level tools such as the low-level hardware description languages described above.

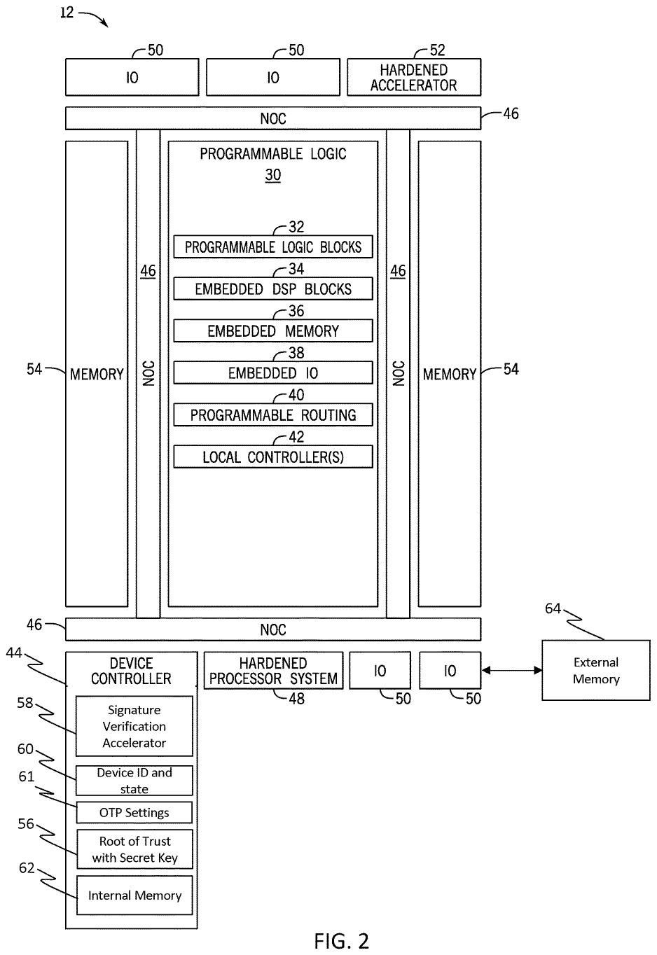

The integrated circuit device 12 may take any suitable form that may implement the system design configuration 14 in any suitable data utilization circuitry. In one example shown in FIG. 2, the integrated circuit device 12 may include data utilization circuitry that includes programmable logic circuitry 30, which may include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling the programmable logic blocks 32 to implement any desired logic circuitry when configured with the system design configuration 14. The programmable logic blocks 32 and are sometimes referred to as logic array blocks (LABs) or configurable logic blocks (CLBs).

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may be programmed into the programmable logic blocks 32 to perform the same functions, but which may not be as efficient as the hardened circuits of the DSP blocks 34. The embedded memory blocks 36 may include dedicated local memory (e.g., blocks of 20 kB, blocks of 1 MB). The embedded IO blocks 38 may allow for inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic circuitry 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic circuitry 30 resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic circuitry 30 of the integrated circuit device 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit device 12. The device controller 44 may include any suitable logic circuitry to control and/or program the programmable logic circuitry 30 or other elements of the integrated circuit device 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally or alternatively, the device controller 44 may include a hardware finite state machine (FSM). The device controller 44 may provide other functions, such as serving as a platform for virtual machines that may manage the operation of the integrated circuit device 12.

A network-on-chip (NOC) 46 may connect the various elements of the integrated circuit device 12. The NOC 46 may provide rapid, packetized communication to and from the programmable logic circuitry 30 and other blocks, such as a hardened processor system 48, high-speed input-output (IO) blocks 50, a hardened accelerator 52, and local device memory 54. The integrated circuit device 12 may include the hardened processor system 48 when the integrated circuit device 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit device 12. The high-speed IO blocks 50 may enable communication using any suitable communication protocol(s) with other devices outside of the integrated circuit device 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic circuitry 30.

As mentioned above, the device controller 44 may manages the operation of the integrated circuit device 12. Among other things, this includes authenticating signed data structures that are provided to the integrated circuit device 12 before operating on them. Thus, the device controller 44 may include several components to facilitate authentication and configuration.

When the device controller 44 receives a signed data structure, such as a configuration bitstream, it may use a root of trust circuit 56 to verify that the signed data structure is authentic. The root of trust circuit 56 may represent any suitable cryptographic control circuitry. In some embodiments, the root of trust circuit 56 is a processor that executes firmware or software. The root of trust circuit may include a secret key that establishes secure operations within the integrated circuit device 12. The secret key may be any suitable device-unique secret that is provisioned during manufacturing or device personalization. The root of trust circuit 56 may use the secret key to generate a message authentication code (MAC) corresponding to the received signed data structure. The root of trust circuit 56 may validate verification keys using provisioned key material and state information. The root of trust circuit 56 may control a signature verification accelerator 58 to provide specialized cryptographic signature verification operations. The signature verification accelerator 58 may support a variety of cryptographic algorithms, including post-quantum cryptographic algorithms that involve numerous hash operations.

Using a device identity and state circuit 60, which holds device-specific information and current operational state, the root of trust circuit 56 may generate a pre-authentication record such as a MAC. The device identity and state circuit 60 may include a monotonic counter for tracking device state. The monotonic counter may be incremented to invalidate previously generated pre-authentication records, thereby preventing replay attacks. The monotonic counter values may be incorporated into pre-authentication record computations to bind the pre-authentication record (e.g., MAC) to a specific device state. One-time-programmable (OTP) settings 61 (e.g., fuses) may define a particular preference for the behavior of the integrated circuit device 12 when a pre-authentication record does not match.

Pre-authentication records may be stored in an internal memory 62 or output to other memory, such as the memory 54 or external memory 64. The internal memory 62 may also store intermediate values or cryptographic keys. The memory 54 or the external memory 64 may store data such as signed data structures like bitstreams along with pre-authentication records once they have been generated. The external memory 64 may include volatile or non-volatile memory (e.g., flash memory). Pre-authentication records generated by the device controller 44 may be exported to the external memory 64 for storage alongside corresponding signed data structures.

A signature verification routine may be implemented using hardware, firmware, or a combination of hardware and firmware to perform an authentication flow. The signature verification accelerator 58 may provide hardware acceleration for computationally intensive cryptographic operations. Firmware executing on the device controller 44 may coordinate the authentication flow and manage interactions between the root of trust circuit 56, the signature verification accelerator 58, and the device identity and state circuit 60. The combination of hardware and firmware may enable flexible implementation of various cryptographic algorithms while maintaining performance for signature verification operations.

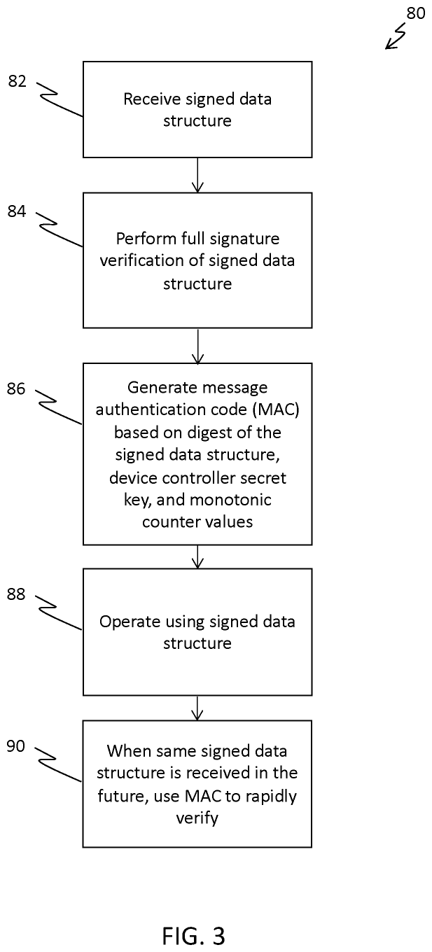

FIG. 3 illustrates a method 80 for pre-authentication of signed data structures in the integrated circuit device 12. The method 80 significantly speeds future uses of a signed data structure by generating a pre-authentication record during an initial authentication operation. Thereafter, the integrated circuit device 12 may use those pre-authentication records for faster verification during subsequent operations.

The method 80 begins at a process block 82, where the device controller 44 receives a signed data structure. The signed data structure may include a configuration bitstream (e.g., system design configuration 14), a firmware image, a certificate, or any other suitable authenticated data structure. The signed data structure may be received from the external memory 64 or from another source via an input-output interface (I/O) 50.

Initially, the first time the signed data structure is provided to the integrated circuit device 12, the device controller 44 performs a full signature verification of the signed data structure (process block 84). The full signature verification may involve validating a digital signature associated with the signed data structure using the root of trust circuit 56 and the signature verification accelerator 58. The root of trust circuit 56 may validate a verification key using provisioned key material and state information from the device identity and state circuit 60. The signature verification accelerator 58 may perform cryptographic operations to verify that the digital signature is valid. For post-quantum cryptographic algorithms, the full signature verification may involve thousands of hash operations.

Following successful verification at the process block 84, the device controller 44 generates a pre-authentication record, such as a message authentication code (MAC), based on a digest of the signed data structure, a device controller secret key, and monotonic counter values (process block 86). The digest may be computed by applying a hash function to the signed data structure. The device controller secret key may be any suitable secret key within the root of trust circuit 56 (e.g., a one-time programmable key, a fused key). The monotonic counter values may be obtained from the received signed data structure and may include a security version number (SVN) applicable to the signed data structure. The combination of the device unique and secret key with the monotonic counter values may produce a derived key that binds the MAC to the specific device, the current device state, and the signed data structure.

Having verified the authenticity of the signed data structure in process block 84, the integrated circuit device 12 may operate using the signed data structure using any suitable data utilization circuitry. For example, when the signed data structure is a configuration bitstream, the device controller 44 may configure the programmable logic 30 according to the configuration bitstream. The MAC generated at the process block 86 may be exported to the external memory 64 or other storage for use in subsequent operations.

Indeed, to rapidly begin using the same signed data structure in the future, the device controller may use the MAC for rapid verification. When the same signed data structure is received in a future boot cycle or reconfiguration operation, the device controller 44 may recompute the MAC using the same derived key and compare the recomputed MAC against the stored MAC. When the MACs match, the device controller 44 may confirm the integrity and authenticity of the signed data structure without performing the full signature verification at the process block 84. This approach may reduce boot and configuration times by replacing computationally intensive digital signature verification with faster MAC-based verification.

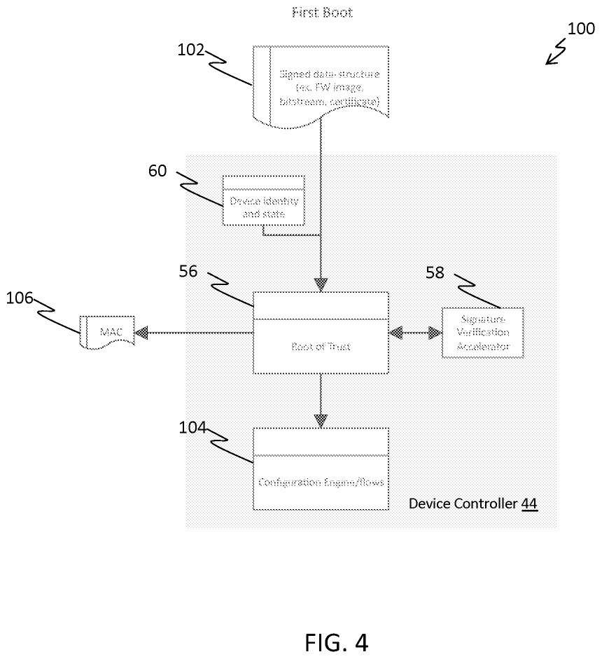

FIG. 4 illustrates a first boot process 100 for the integrated circuit device 12. The first boot process 100 depicts the flow of operations when the device controller 44 initially boots and performs a full signature verification. In FIG. 4, a signed data structure 102, which may include a firmware image, a bitstream, or a certificate, is provided to the device controller 44 for authentication.

The root of trust circuit 56 uses the signed data structure 102 and provisioned key material and state information from the device identity and state circuit 60 to perform a full signature verification using the signature verification accelerator 58. The signature verification accelerator 58 executes cryptographic operations to verify the digital signature associated with the signed data structure 102. For post-quantum cryptographic algorithms, the signature verification may involve thousands of hash operations.

Upon successful verification of the signed data structure 102, a configuration engine 104 within the device controller 44 applies the configuration to the integrated circuit device 12. For example, the configuration engine 104 may configure the programmable logic 30 according to the signed data structure 102 when the signed data structure 102 is a configuration bitstream.

The first boot process 100 includes an additional operation compared to a normal boot process. The root of trust circuit 56 creates a pre-authentication record (e.g., a message authentication code (MAC) 106) based on the signed data structure 102 and the device identity and state circuit 60. The MAC 106 is computed using a digest of the signed data structure 102, a device-unique secret key from the root of trust circuit 56, and monotonic counter values from the device identity and state circuit 60. The MAC 106 is unique to the combination of the specific integrated circuit device 12 and the signed data structure 102 being authenticated.

The MAC 106 may be exported to be stored alongside the signed data structure (e.g., bitstream) in the memory 54 or the external memory 64. A device owner may store the MAC 106 in the external memory 64 for use in subsequent boot cycles. By storing the MAC 106 alongside the corresponding signed data structure 102, the integrated circuit device 12 may perform faster authentication during future boot operations by verifying the MAC 106 rather than performing the full digital signature verification.

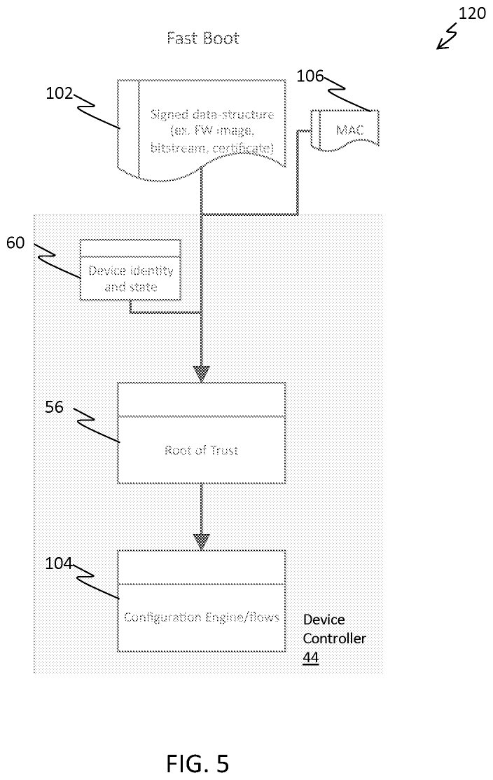

FIG. 5 illustrates a fast boot process 120 for the integrated circuit device 12. The fast boot process 120 depicts the flow of authentication and configuration when a pre-authentication record is available from a previous boot cycle. In the fast boot process 120, the signed data structure 102 and the MAC 106 are provided to the device controller 44. The MAC 106 was previously generated during the first boot process 100 and stored alongside the signed data structure 102 (e.g., in the external memory 64).

The root of trust circuit 56 receives the signed data structure 102 and the MAC 106. The root of trust circuit 56 performs verification based on the signed data structure 102 and the device identity and state circuit 60. The root of trust circuit 56 computes a digest of the signed data structure 102 and generates a new MAC using the same device-unique secret key and monotonic counter values that were used during the first boot process 100. The root of trust circuit 56 compares the computed new MAC against the previously computed MAC 106 that was received.

When the new computed MAC matches the received MAC 106, the root of trust circuit 56 confirms that the MAC 106 was computed by the same integrated circuit device 12 for the same signed data structure 102. The match indicates that the integrity and authenticity of the signed data structure 102 have been verified. The configuration engine 104 within the device controller 44 then may proceed with configuration without performing full signature verification. By bypassing the computationally intensive digital signature verification, the fast boot process 120 may significantly reduce boot and configuration times.

The speed-up provided by the fast boot process 120 may be substantial. A typical SLH-DSA verification requires about 4.5k hash operations to complete verification of a single signed data structure. In contrast, MAC generation and verification may involve a comparatively small number of AES or SHA operations. The reduction from thousands of hash operations to a small number of AES or SHA operations provides a significant reduction in computational overhead and time.

MAC creation and handling may be performed using quantum-resistant primitives such as SHA and AES. These primitives provide resistance against quantum-based attacks. Because the MAC-based verification relies on symmetric cryptographic operations rather than asymmetric signature verification, the fast boot process 120 maintains security against quantum computing threats while providing faster authentication than post-quantum digital signature verification algorithms.

When MAC verification fails during the fast boot process, the device controller may respond in different ways depending on configuration settings. A MAC mismatch occurs when the recomputed MAC does not match the received MAC that was previously stored alongside the signed data structure. The mismatch may indicate that the signed data structure has been modified, that the device state has changed (e.g., the monotonic counter has been incremented), or that the MAC was generated by a different device.

In response to a MAC mismatch, the device controller 44 may take several courses of action. In some cases, these may be selectable through the OTP settings 61. In one example, the device controller 44 may reject the boot operation and generate an error message. The error message may indicate that pre-authentication verification failed and that the signed data structure cannot be authenticated using the stored MAC. Rejecting the boot operation may prevent the device from operating with a potentially compromised or unauthorized signed data structure.

Additionally or alternatively, in response to a MAC mismatch, the device controller 44 may default back to the regular boot process with full signature verification. Rather than rejecting the boot operation outright, the device controller 44 may perform the computationally intensive digital signature verification that would otherwise be bypassed during fast boot. If the full signature verification succeeds, the device controller 44 may proceed with configuration and may generate a new MAC for future use. If the full signature verification fails, the device controller 44 may reject the boot operation.

The behavior in case of MAC verification error may be determined in different ways. In some cases, the device manufacturer may impose a particular error handling behavior. The device manufacturer may configure the device during manufacturing to either reject boot operations upon MAC mismatch or to fall back to full signature verification. This approach may provide consistent behavior across all devices from the manufacturer.

In other cases, the device owner may determine the error handling behavior through a one-time-programmable (e.g., fuse) option. For instance, the device owner may program the OTP settings 61 (e.g., programming one or more fuses) during device personalization to select between rejecting boot operations upon MAC mismatch or falling back to full signature verification. The fuse option may provide flexibility for device owners to configure error handling behavior according to their security requirements and operational preferences. For example, a device owner with strict security requirements may configure the device to reject boot operations upon any MAC mismatch, while a device owner prioritizing availability may configure the device to fall back to full signature verification.

The MAC may be invalidated by incrementing the monotonic counter. This approach uses the same mechanism as the cancellation of signatures of signed data structures to avoid replay attacks. Because the MAC is computed using monotonic counter values as part of the key derivation or MAC computation, any change to the monotonic counter value will cause a mismatch between a previously stored MAC and a newly computed MAC.

When a device owner or the device itself increments the monotonic counter, all previously generated MACs that were computed using the prior counter value become invalid. The invalidation occurs because the MAC verification process recomputes the MAC using the current monotonic counter value. Since the current counter value differs from the counter value used when the original MAC was generated, the recomputed MAC will not match the stored MAC. This mismatch causes the fast boot verification to fail, preventing the use of the previously authenticated signed data structure without performing a new full signature verification.

The relationship between counter values and MAC validity provides a mechanism for maintaining security over time. When a security vulnerability is discovered in a signed data structure, or when a device owner wishes to revoke authorization for a previously authenticated signed data structure, the monotonic counter may be incremented. The increment operation invalidates all MACs that were generated prior to the increment, thereby requiring any signed data structures to undergo full signature verification before they can be used again.

The monotonic counter approach prevents replay attacks by binding the MAC to a specific device state. An attacker who obtains a valid MAC for a signed data structure cannot use that MAC after the monotonic counter has been incremented. Even if the attacker possesses both the signed data structure and the corresponding MAC, the MAC verification will fail because the device will compute a new MAC using the updated counter value. The attacker cannot forge a valid MAC for the new counter value without access to the device-unique secret key.

The monotonic counter may be associated with a security version number (SVN) applicable to the signed data structure. When a new version of a signed data structure is deployed with an updated SVN, the monotonic counter may be incremented to correspond to the new SVN. This increment invalidates any MACs generated for previous versions of the signed data structure, ensuring that only the current version can benefit from fast boot verification. If the signature verification fails due to SVN policy enforcement, the previous versions would be rejected.

The MAC generation functionality may be exposed as a cryptographic service. The cryptographic service may enable a device owner to pre-generate MACs before deployment of the integrated circuit device in a production setting. Rather than generating MACs during the first boot of each device in the field, the device owner may use the cryptographic service to generate MACs in a controlled environment prior to deployment.

The cryptographic service may accept a signed data structure and device-specific parameters as inputs. The cryptographic service may compute the MAC using the same algorithm and key derivation process that would be used during a first boot operation. The device owner may invoke the cryptographic service for each signed data structure that will be used with a particular integrated circuit device. The cryptographic service may return the computed MAC to the device owner for storage alongside the corresponding signed data structure.

Pre-generating MACs before deployment may provide several benefits for production workflows. The device owner may prepare all MACs for a fleet of devices before shipping the devices to their final deployment locations. When the devices arrive at their deployment locations and boot for the first time, the devices may immediately use the pre-generated MACs for fast boot verification. The devices may avoid the computational overhead of full signature verification during the first boot in the field.

The cryptographic service approach may reduce deployment time in production environments. When deploying a large number of devices, the cumulative time savings from avoiding full signature verification on first boot may be substantial. The device owner may pre-generate MACs in parallel for multiple devices using computing resources in a manufacturing or staging facility. The pre-generated MACs may be loaded into external storage alongside the corresponding signed data structures before the devices are shipped.

The cryptographic service may also simplify device provisioning workflows. The device owner may integrate MAC generation into existing provisioning processes that prepare signed data structures for deployment. The device owner may generate MACs as part of the same workflow that generates or obtains signed configuration bitstreams. The integration may reduce the number of separate steps in the provisioning process.

The cryptographic service may require secure handling of device-specific secrets. The cryptographic service may operate within a secure environment that has access to the device-unique secret keys used for MAC generation. The device owner may implement appropriate security controls to protect the device-specific secrets during the MAC generation process. The security controls may include hardware security modules, secure enclaves, or other mechanisms for protecting cryptographic keys.

Pre-authentication may extend beyond regular boot-time bitstreams to other types of signed data structures. The pre-authentication approach may be applied to validation bitstreams, partial reconfiguration images, and tokens. Partial reconfiguration images may benefit from pre-authentication because partial reconfiguration operations may occur frequently during device operation, and reducing the time for each reconfiguration operation may improve overall system efficiency.

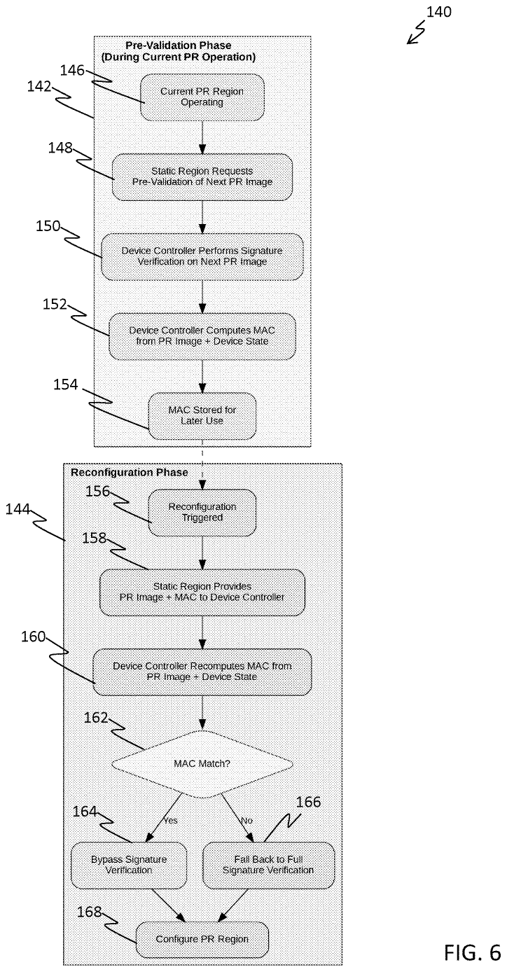

FIG. 6 illustrates a process 140 for pre-validation and reconfiguration of partial reconfiguration images in the integrated circuit device 12. The process 140 is divided into a pre-validation phase 142 and a reconfiguration phase 144. The pre-validation phase 142 may even occur while a current partial reconfiguration region is operating, thereby enabling the device controller 44 to perform computationally intensive signature verification operations without downtime in between partial reconfiguration phases.

The pre-validation phase 142 begins at a process block 146. During this time, the programmable logic 30 within the partial reconfiguration region may execute its configured functionality. Meanwhile, a static region of the integrated circuit device 12 remains operational and may coordinate preparation for a subsequent reconfiguration operation.

At a process block 148, the static region may request pre-validation of a next partial reconfiguration image. The static region may send a request to the device controller 44 to authenticate the next partial reconfiguration image in advance of the actual reconfiguration operation. The next partial reconfiguration image may be retrieved from the external memory 64 or received from another source.

At a process block 150, the device controller 44 performs signature verification on the next partial reconfiguration image. The root of trust circuit 56 and the signature verification accelerator 58 execute the full digital signature verification process. The signature verification may involve validating a verification key using provisioned key material and state information from the device identity and state circuit 60. For post-quantum cryptographic algorithms, the signature verification may involve thousands of hash operations.

Following successful signature verification at the process block 150, the device controller 44 computes a pre-authentication record (e.g., a MAC) from the partial reconfiguration image and the device state at a process block 152. The MAC may be computed using a digest of the partial reconfiguration image, a device-unique secret key from the root of trust circuit 56, and monotonic counter values from the device identity and state circuit 60. The MAC binds the authenticated partial reconfiguration image to the specific integrated circuit device 12 and the current device state.

At a process block 154, the MAC is stored for later use during the reconfiguration phase 144. The MAC may be stored in the internal memory 62, the memory 54, or the external memory 64. By storing the MAC while the current partial reconfiguration region continues to operate, the device controller 44 completes the computationally intensive authentication work in advance of the actual reconfiguration operation.

The static region may prepare the partial reconfiguration operation by pre-validating the next partial reconfiguration image while the current partial reconfiguration region is still operating. This approach enables the signature verification operations to occur in parallel with the ongoing operation of the current partial reconfiguration region. When reconfiguration is triggered, the device controller 44 may use the stored MAC to verify the partial reconfiguration image without performing the full signature verification again. The pre-validation approach may reduce downtime between partial reconfiguration operations by shifting the computational burden of signature verification to a time when the device is otherwise productively operating.

The reconfiguration phase 144 begins at a process block 156, where reconfiguration is triggered. The trigger may occur when the current partial reconfiguration region completes its task, when a system event requires a change in functionality, or when an external command initiates the reconfiguration operation, or the like. At this point, the pre-validation phase 142 has already completed, and the MAC for the next partial reconfiguration image has been stored.

At a process block 158, the static region provides the partial reconfiguration image and the MAC to the device controller 44. The partial reconfiguration image may be retrieved from the external memory 64 or from another storage location. The MAC that was computed and stored during the pre-validation phase 142 accompanies the partial reconfiguration image. The device controller 44 receives both the partial reconfiguration image and the corresponding MAC for verification.

At a process block 160, the device controller 44 recomputes the MAC from the partial reconfiguration image and the device state. The root of trust circuit 56 computes a digest of the partial reconfiguration image and generates a new MAC using the same device-unique secret key and monotonic counter values from the device identity and state circuit 60 that were used during the pre-validation phase 142. The recomputation produces a MAC value that may be compared against the stored MAC.

At a process block 162, the device controller 44 compares the recomputed MAC against the stored MAC. The comparison determines whether the partial reconfiguration image matches the image that was pre-validated during the pre-validation phase 142. The comparison also confirms that the device state has not changed in a manner that would invalidate the stored MAC.

When the recomputed MAC matches the stored MAC, the process 140 proceeds to a process block 164, where signature verification is bypassed. The match indicates that the partial reconfiguration image is the same image that was authenticated during the pre-validation phase 142 and that the device state remains consistent. The device controller 44 may proceed with configuration without performing the computationally intensive digital signature verification again. Bypassing the signature verification reduces the downtime between partial reconfiguration operations.

When the recomputed MAC does not match the stored MAC, the process 140 proceeds to a process block 166, where full signature verification is performed. The mismatch may indicate that the partial reconfiguration image has been modified, that the device state has changed, or that an error occurred during storage or retrieval of the MAC. The device controller 44 performs the full digital signature verification using the root of trust circuit 56 and the signature verification accelerator 58. If the full signature verification succeeds, the device controller 44 may proceed with configuration. If the full signature verification fails, the device controller 44 may reject the reconfiguration operation.

Both paths from the process block 162 converge at a process block 168, where the partial reconfiguration region is configured. The configuration engine 104 within the device controller 44 applies the partial reconfiguration image to the programmable logic 30 within the partial reconfiguration region. The partial reconfiguration region begins operating according to the new configuration.

Additionally or alternatively, the device controller 44 may store a MAC in the internal memory 62 for consumption during a next partial reconfiguration operation within the same power-cycle. In this example, the MAC may be a hash of the partial reconfiguration image. The device controller 44 stores the MAC in protected memory rather than exporting the MAC to the external memory 64. During the same power-cycle, when the next partial reconfiguration operation occurs, the device controller 44 retrieves the stored MAC from the internal memory 62 and uses the MAC for verification. This variant may provide faster access to the stored MAC because the internal memory 62 may be accessed more quickly than the external memory 64. The variant may be suitable for scenarios where multiple partial reconfiguration operations occur within a single power-cycle and where the partial reconfiguration images are pre-validated in sequence.

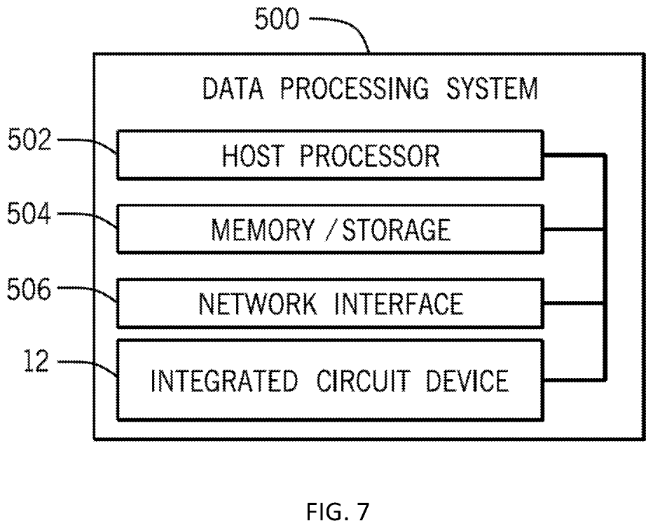

The integrated circuit device 12 discussed above may be a component included in a data processing system, such as a data processing system 500, shown in FIG. 7. The data processing system 500 may include the integrated circuit device 12 (e.g., a programmable logic device, an application specific integrated circuit (ASIC), a DSP), a host processor 502, memory and/or storage circuitry 504, and a network interface 506 (e.g., a transceiver). The data processing system 500 may include more or fewer components (e.g., electronic display, user interface structures, application specific integrated circuits (ASICs)). The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams) for programming the integrated circuit device 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. An integrated circuit device comprising:
   a device controller to verify a signature of a signed data structure based on:
during an initial boot sequence, computing a full signature verification and computing and storing a message authentication code; and
during a subsequent boot sequence, recomputing the message authentication code and comparing the recomputed message authentication code to the stored message authentication code;
   data utilization circuitry to use the signed data structure based on the signature of the signed data structure being verified.
EXAMPLE EMBODIMENT 2. The integrated circuit device of example embodiment 1, wherein the device controller is to verify the signature, during the subsequent boot sequence, without recomputing the full signature verification when the recomputed message authentication code matches the stored message authentication code.
EXAMPLE EMBODIMENT 3. The integrated circuit device of example embodiment 1, wherein the device controller is to compute the message authentication code based on the digest of the signed data structure, the device-unique secret key, and a monotonic counter value corresponding to the signed data structure.
EXAMPLE EMBODIMENT 4. The integrated circuit device of example embodiment 3, wherein the device controller is to compute the pre-authentication record based on a hash function applied to the signed data structure to produce the digest.
EXAMPLE EMBODIMENT 5. The integrated circuit device of example embodiment 3, wherein the device controller comprises:
a root of trust circuit to store the device-unique secret key; and
a signature verification accelerator to perform computation for the full signature verification.
EXAMPLE EMBODIMENT 6. The integrated circuit device of example embodiment 1, wherein the device controller is to, based on the recomputed pre-authentication record not matching the stored pre-authentication record, perform the full signature verification of the signed data structure.
EXAMPLE EMBODIMENT 7. The integrated circuit device of example embodiment 1, wherein the data utilization circuitry comprises programmable logic circuitry and the signed data structure comprises a configuration bitstream to be programmed into the programmable logic circuitry.
EXAMPLE EMBODIMENT 8. The integrated circuit device of example embodiment 1, wherein the device controller is configured to output the message authentication code for storage with the signed data structure.
EXAMPLE EMBODIMENT 9. The integrated circuit device of example embodiment 1, wherein the signed data structure comprises a partial reconfiguration image, a validation bitstream, a token, or any combination thereof.
EXAMPLE EMBODIMENT 10. The integrated circuit device of example embodiment 1, wherein the device controller is to compute the full signature verification based on a post-quantum cryptographic algorithm.
EXAMPLE EMBODIMENT 11. The integrated circuit device of example embodiment 1, wherein the device controller is to compute the message authentication code based on a post-quantum cryptographic algorithm.
EXAMPLE EMBODIMENT 12. A method comprising:
   receiving, at a first time, a signed data structure in an integrated circuit device;
   performing a full signature verification of the signed data structure in the integrated circuit device;
   based on the full signature verification confirming that the signed data structure is authentic, determining a message authentication code based on information corresponding to the signed data structure and the integrated circuit device;
   storing the message authentication code for future use in verifying the authenticity of the signed data structure in the future.
EXAMPLE EMBODIMENT 13. The method of example embodiment 12, comprising, based on the full signature verification confirming that the signed data structure is authentic using the signed data structure in data utilization circuitry of the integrated circuit device.
EXAMPLE EMBODIMENT 14. The method of example embodiment 12, wherein the signed data structure comprises a configuration bitstream, a validation bitstream, a token, or any combination thereof.
EXAMPLE EMBODIMENT 15. The method of example embodiment 12, comprising:
   receiving, at a second time subsequent to the first time, the signed data structure in the integrated circuit device;
   recomputing the message authentication code in the integrated circuit device;
   comparing the recomputed message authentication code and the stored message authentication code in the integrated circuit device; and
   when the recomputed message authentication code matches the stored message authentication code, confirming that the signed data structure is authentic without again performing the full signature verification.
EXAMPLE EMBODIMENT 16. The method of example embodiment 15, wherein, when the recomputed message authentication code does not match the stored message authentication code, performing the full signature verification.
EXAMPLE EMBODIMENT 17. The method of example embodiment 15, wherein, when the recomputed message authentication code does not match the stored message authentication code, issuing an error without performing the full signature verification.
EXAMPLE EMBODIMENT 18. The method of example embodiment 12, wherein determining the message authentication code based on the information corresponding to the signed data structure and the integrated circuit device comprises determining the message authentication code based on a digest of the signed data structure, a device-unique secret key, and a monotonic counter value.
EXAMPLE EMBODIMENT 19. A tangible, non-transitory, computer-readable medium storing instructions that, when executed by a processor of a device controller, cause the device controller to:
receive a signed data structure and a pre-authentication record associated with the signed data structure;
compute a digest of the signed data structure;
generate a verification value based on the digest, a device-unique secret key, and a monotonic counter value;
compare the verification value against the pre-authentication record; and
configure programmable logic of an integrated circuit device using the signed data structure without performing a full digital signature verification based on the verification value matching the pre-authentication record.
EXAMPLE EMBODIMENT 20. The tangible, non-transitory, computer-readable medium of example embodiment 19, wherein the instructions cause the device controller to, based on the verification value not matching the pre-authentication record, perform the full digital signature verification of the signed data structure.

What is claimed is:

1. An integrated circuit device comprising:
a device controller to verify a signature of a signed data structure based on:
during an initial boot sequence, computing a full signature verification and computing and storing a message authentication code; and
during a subsequent boot sequence, recomputing the message authentication code and comparing the recomputed message authentication code to the stored message authentication code;
data utilization circuitry to use the signed data structure based on the signature of the signed data structure being verified.

2. The integrated circuit device of claim 1, wherein the device controller is to verify the signature, during the subsequent boot sequence, without recomputing the full signature verification when the recomputed message authentication code matches the stored message authentication code.

3. The integrated circuit device of claim 1, wherein the device controller is to compute the message authentication code based on the digest of the signed data structure, the device-unique secret key, and a monotonic counter value corresponding to the signed data structure.

4. The integrated circuit device of claim 3, wherein the device controller is to compute the pre-authentication record based on a hash function applied to the signed data structure to produce the digest.

5. The integrated circuit device of claim 3, wherein the device controller comprises:
a root of trust circuit to store the device-unique secret key; and
a signature verification accelerator to perform computation for the full signature verification.

6. The integrated circuit device of claim 1, wherein the device controller is to, based on the recomputed pre-authentication record not matching the stored pre-authentication record, perform the full signature verification of the signed data structure.

7. The integrated circuit device of claim 1, wherein the data utilization circuitry comprises programmable logic circuitry and the signed data structure comprises a configuration bitstream to be programmed into the programmable logic circuitry.

8. The integrated circuit device of claim 1, wherein the device controller is configured to output the message authentication code for storage with the signed data structure.

9. The integrated circuit device of claim 1, wherein the signed data structure comprises a partial reconfiguration image, a validation bitstream, a token, or any combination thereof.

10. The integrated circuit device of claim 1, wherein the device controller is to compute the full signature verification based on a post-quantum cryptographic algorithm.

11. The integrated circuit device of claim 1, wherein the device controller is to compute the message authentication code based on a post-quantum cryptographic algorithm.

12. A method comprising:
receiving, at a first time, a signed data structure in an integrated circuit device;
performing a full signature verification of the signed data structure in the integrated circuit device;
based on the full signature verification confirming that the signed data structure is authentic, determining a message authentication code based on information corresponding to the signed data structure and the integrated circuit device;
storing the message authentication code for future use in verifying the authenticity of the signed data structure in the future.

13. The method of claim 12, comprising, based on the full signature verification confirming that the signed data structure is authentic using the signed data structure in data utilization circuitry of the integrated circuit device.

14. The method of claim 12, wherein the signed data structure comprises a configuration bitstream, a validation bitstream, a token, or any combination thereof.

15. The method of claim 12, comprising:
receiving, at a second time subsequent to the first time, the signed data structure in the integrated circuit device;
recomputing the message authentication code in the integrated circuit device;
comparing the recomputed message authentication code and the stored message authentication code in the integrated circuit device; and
when the recomputed message authentication code matches the stored message authentication code, confirming that the signed data structure is authentic without again performing the full signature verification.

16. The method of claim 15, wherein, when the recomputed message authentication code does not match the stored message authentication code, performing the full signature verification.

17. The method of claim 15, wherein, when the recomputed message authentication code does not match the stored message authentication code, issuing an error without performing the full signature verification.

18. The method of claim 12, wherein determining the message authentication code based on the information corresponding to the signed data structure and the integrated circuit device comprises determining the message authentication code based on a digest of the signed data structure, a device-unique secret key, and a monotonic counter value.

19. A tangible, non-transitory, computer-readable medium storing instructions that, when executed by a processor of a device controller, cause the device controller to:
receive a signed data structure and a pre-authentication record associated with the signed data structure;
compute a digest of the signed data structure;
generate a verification value based on the digest, a device-unique secret key, and a monotonic counter value;
compare the verification value against the pre-authentication record; and
configure programmable logic of an integrated circuit device using the signed data structure without performing a full digital signature verification based on the verification value matching the pre-authentication record.

20. The tangible, non-transitory, computer-readable medium of claim 19, wherein the instructions cause the device controller to, based on the verification value not matching the pre-authentication record, perform the full digital signature verification of the signed data structure.
